(19) United States
(12) Patent Application Publication
(10) Pub. No.: US 2011/0183101 A1
(43) Pub. Date: Jul. 28, 2011

(54) Floor covering and method for its production

(75) Inventors: Bernhard Voith, Ottenbach (DE); Bernd Fischer, Murr (DE); Karl-Heinz Peter Scholz, Hoesbach (DE)

(73) Assignees: TPS TechnoPartner Samtronic GmbH, Goeppingen (DE); Karl-Heinz Peter Scholz, Hoesbach (DE)

(21) Appl. No.: 12/930,744

(22) Filed: Jan. 14, 2011

(30) Foreign Application Priority Data
Jan. 15, 2010 (DE) 10 2010 005 068.7
Jan. 15, 2010 (DE) 20 2010 001 149.3

(51) Int. Cl. E04F 15/02; B32B 3/10; B32B 9/00; B32B 21/08; B32B 27/06; B32B 37/02; B32B 37/06; B32B 37/08; B32B 37/10; B32B 37/26; B32B 38/10

(52) U.S. Cl. 428/53; 428/67; 428/77; 428/54; 156/250

(57) ABSTRACT

In the case of a floor covering that consists of at least one layer of a thermoplastic material, sections of the surface of the floor covering are composed of stone tiles or a natural material, according to the invention, whereby these sections are disposed spaced apart from one another, in each instance, or to lie against one another, in each instance. By means of the effect of heat during production of the floor covering, the stone tiles or the natural material become integral with the thermoplastic material and are wetted from the underside by the thermoplastic material.

The invention relates to floor covering in accordance with the preamble of claim 1, and to a method for its production.

A plurality of floor coverings that consist of meltable starting materials is known. These starting materials are present as a granulate, so-called flakes, or also as a powder. In part, particles having a different color are mixed into these materials, so that a decorative pattern forms on the surface of the floor covering. In part, the surfaces of the floor coverings are also provided with an embossed surface, so that a desired design becomes possible.

However, if stone surfaces are being simulated in floor coverings, for example, then these surfaces lack the typical shine and the natural appearance of stone.

The production of floor coverings or similar webs and the machines for this are known, for example, from the documents DE 197 51 516 C2 (U.S. Pat. No. 6,217,700 B1) and DE 10 2007 063 261 A1. In the production process, the thermoplastically deformable starting materials are uniformly spread out onto a lower, circulating belt. During the further production process, finally, an upper, circulating belt presses down onto the starting material. The starting materials are heated or partly melted in the conveying gap between these two belts, by means of a heating system, and pressed against one another. Pressing takes place by means of pressing plates or pressing rollers disposed in pairs on both sides of the belts. At the end of production, cooling of the web that has been formed in this manner takes place, and it is then either cut to length in panels or rolled up.

In many cases, floor coverings that consist of stone tiles are also desired on the market. These stone tiles are floor tiles (ceramic tiles) and/or natural stones. These are then laid in a mortar bed. However, this laying has the disadvantage that it is very time-consuming and costly.

Furthermore, floor coverings made of natural stone are very expensive, because for strength reasons, they require a minimum thickness, so that they do not break when they are transported or laid.

Furthermore, there is the disadvantage that such stone floors are often felt to be too cold in the case of unheated floors.

Also, there is a significant expenditure of costs as well as dirt if these stone floors are to be removed again.

It is therefore the task of the invention to find a floor covering that allows the design of natural materials, particularly stone material, without the disadvantages indicated above occurring, and a method for its production.

This task is accomplished by means of a floor covering having the characteristics of claim 1. Advantageous embodiment variants of the invention are indicated with the dependent claims 2 to 25.

A method having the characteristics of claim 26 is provided, according to the invention, for the production of such floor coverings. The dependent claims 27 to 32 disclose embodiment variants of the method.

The essence of the invention is, for one thing, that sections of the surface of such a floor covering consist of stone tiles or of natural material, and for another, that the stone tiles or the natural material, a stone material that can be split finely or a wood material that can be split finely, are integral with the thermoplastic material of the floor covering. The sections of the floor covering are disposed spaced apart from one another, in each instance, or to lie against one another, in each instance.

According to the invention, the stone tiles or the natural material, at least one layer of the finely splittable stone material or of the finely splittable wood material, can furthermore be introduced into a related machine for the production of thermoplastic floor coverings, together with the thermoplastic material. By means of heating and pressing the thermoplastic layer and the stone tiles or the natural material, not only is the thermoplastic material partly melted, but also, the thermoplastic material wets the underside of the stone tiles or of the natural material, and thereby the two materials are firmly connected with one another.

Within the scope of the invention, stone tiles are understood to be not only ceramic tiles (in other words fired tiles, stoneware) or panels produced from stone meal, or panels that contain stone meal or stone granulate, but also calibrated natural stone tiles. Calibrated natural stone tiles are understood to be natural stones that have previously been brought to a defined thickness. Here, marble, sandstone, granite or basalt will be mentioned as examples of natural stone—but not in restrictive manner.

In the production process, the thermoplastic granulate is applied to a lower pressing belt of the production machine, and the natural material is laid on top; according to the first embodiment of the invention, this material is the stone tiles.

Laying on the stone tiles can take place by means of a handling system, for example. In order for the granulate and the stone tiles to be able to be pressed together, an upper pressing belt is also present during the further course of production. The two pressing belts are pressed by pressing plates and/or pressing rollers disposed in pairs—which are disposed on the side of the pressing belts that faces away from the material to be pressed.

In order for no damage to occur to the belt that faces the stone tiles, or to the surface of the stone tiles, an auxiliary belt that is elastic in thickness is allowed to run along between the corresponding pressing belt and the surface of the stone tiles.

The production process described above furthermore has the advantage that thicker stone tiles can be pressed deeper into the soft subsurface of the thermoplastic material, so that the total of the two layers always remains constant. The floor covering according to the invention is calibrated in terms of its thickness, so to speak.

Within the scope of the invention, the subsurface below the stone tiles can consist not just of one layer, and also not just of pure thermoplastic material. In advantageous manner, the layers can also consist of plastics and natural materials—such as sisal fibers, coconut fibers, or cork. In this connection, the plastics can also be filled with usual admixtures such as stone meals or the aforementioned natural substances or fibers.

Furthermore, it is advantageous if the floor covering is configured to be electrically conductive—for example by means of carbon black or carbon fibers. Electrostatic discharge can take place by way of one of the lower elastic layers or by way of the joins.

According to the invention, it is also possible to configure the underside of the floor covering according to the invention to be self-adhesive or also magnetic. Self-adhesion can be implemented by way of suitable adhesives or also suction cups, while the magnetic property of the floor covering can be implemented by way of embedded barium or strontium ferrite, with subsequent magnetization, and a subsurface that contains iron.

According to a second and a third embodiment of the invention, the natural material used is a stone material that can be finely split, or a wood material that can be finely split.

The inventors have recognized that there are stone materials that consist of very thin layers, which furthermore have only slight cohesion with one another. There is the problem that very thin layers (in the range of 1 to 3 mm) cannot be split using splitting tools, because then, bending toward the layer to be split off occurs as the result of the introduction of the splitting tool, causing this layer to break off.

However, if, according to the invention, a fine-layer stone material, before splitting, is first saturated with a connecting agent, which is at first in gaseous or liquid form and becomes a firm layer, particularly an elastic layer, after being applied, then the stone material experiences a supporting network structure (comparable with a glass nonwoven), so that it is actually possible to apply bending forces to the stone layer, without this layer breaking.

Such a connecting agent can be a synthetic resin, for example, which is used solo, or added to the glass nonwoven granulate, or a thin glass nonwoven is laid onto the said stone material before the synthetic resin is applied.

Now one can regularly pull the stone layer off from the edge of a stone block, using a tool, and a stone film is obtained. This saturation with a connecting agent, for example synthetic resin, furthermore has the advantage that at the same time, a substance that can be connected with adjacent materials is present in the stone.

The production of floor coverings that consist of at least one layer of thermoplastic material, or similar webs, and the machines for this, are known, for example, from the documents already mentioned, U.S. Pat. No. 6,217,700 B1 and DE 10 2007 063 261 A1.

During the production process, the thermoplastically deformable starting materials are uniformly spread onto a lower belt. During the further production sequence, finally, an upper belt also presses down onto the starting material. In the gap between the two belts, the starting materials are heated and partly melted by means of an additional heating system, and pressed together with one another. Pressing takes place by way of pressing plates or pressing rollers disposed in pairs on both sides of the belts. At the end, cooling of the web that has been formed in this manner takes place, and this is then cut to length in panels or rolled up.

In order to connect fine, thin natural material layers, particularly stone layers (called stone films hereinafter), with webs produced in the thermoplastic method indicated above, one can either lay the stone films into the machine directly during the production process of the web, or connect them with the web that has already been produced, in a second production process.

In the production of the floor covering according to the invention, first the stone films can be laid onto the lower belt and then the granulates of the other materials can be spread on, or the various granulates of the other materials are spread on first and then the stone films are laid down.

In order for the surfaces of the stone films not to damage the conveyor belt of the machine, or, vice versa, so that the stone surface cannot be crushed, it is possible to pass a silicone belt through the machine between the surface of the stone film and the conveyor belt, as well. This silicone belt is then unwound from a roll-off mechanism (reel or drum) at the beginning of the machine, and wound up again at the end of the machine.

Finally, once this silicone belt has run through the machine in its entirety, it can be brought back to the beginning of the machine, so that it can serve as a protective belt once again.

Natural slate and other types of stone that can be finely split, such as Indian slate and mica, have proven to be particularly suitable as stone films for the floor covering according to the invention. In this connection, the thickness of the stone films amounts to between 1 to 3 mm, preferably 1 to 1.5 mm.

It has been shown that the layer under the stone film, in each instance, a so-called intermediate layer, should consist of an elastic material. In this connection, this intermediate layer also serves as an equalization layer, i.e. variations in the thickness of the stone film are undertaken by means of compensation of the thickness of the intermediate layer. The elastic material of the intermediate layer consists of thermoplastically bonded elastic admixtures, such as rubber meal or rubber granulate, and/or cork meal. If applicable, the intermediate layer can also contain natural fibers.

Underneath the intermediate layer, a layer of elastified natural materials and elastified binders has proven to be advantageous. Here, cork, bamboo fibers, coconut fibers or sisal fibers are possible natural materials.

After the stone films have been thermoplastically bonded to the other materials, individual panels or a web having a specific length and width is produced by means of a device, for example a saw, and these then represent the floor covering according to the invention.

Above, it was already mentioned that the natural material used according to the third embodiment of the invention is a finely splittable wood material.

The wood material is split using the methods that are known from veneer production. This means that the veneers are produced by means of peeling also so-called blade-cutting, or—although in rare cases—by means of sawing. Synthetic resin can also be used to connect the veneers with the thermoplastic material. Here, the layer thicknesses of the wood material can amount to from 0.5 to 5 mm; preferably the layer thicknesses are 1 to 2 mm.

A floor covering having a thermoplastic subsurface and veneer as the cover layer also has the advantage that the surface of the covering represents a natural product and, at the same time, is not cold to the feet.

The invention according to the first embodiment will be explained in greater detail in the following, using figures. These show, in a schematic representation:

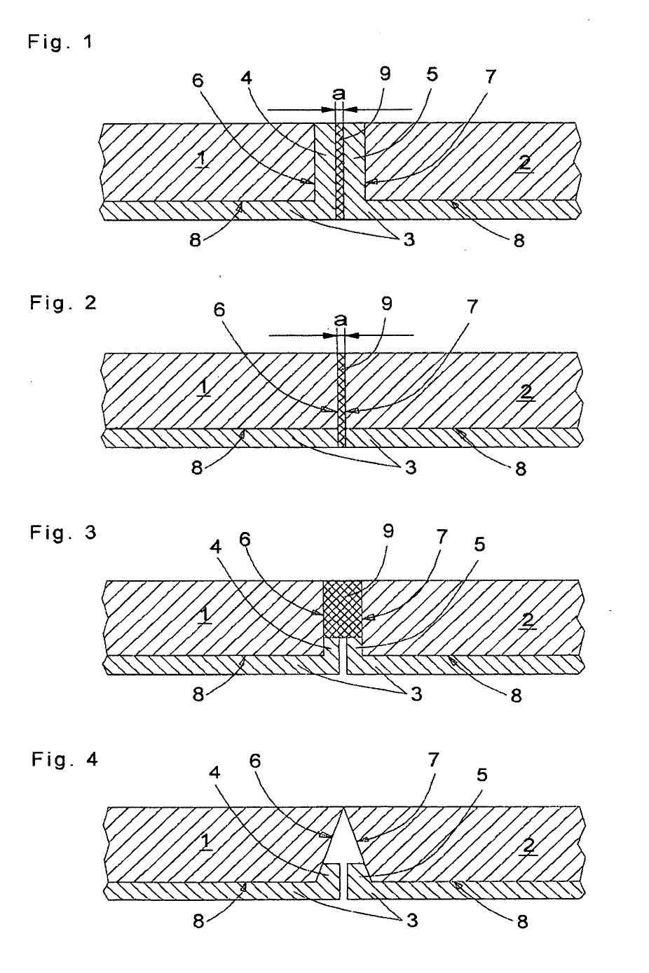

FIG. 1 a detail of an embodiment of a floor covering according to the invention, in which the flanks of the stone tiles are provided with an overhang;

FIG. 2 a detail of a floor covering in which the flanks of the stone tiles are not provided with an overhang;

FIG. 3 a detail of a floor covering in which the flanks of the stone tiles are partly provided with an overhang;

FIG. 4 a detail of a floor covering in which the flanks of the stone tiles are not parallel;

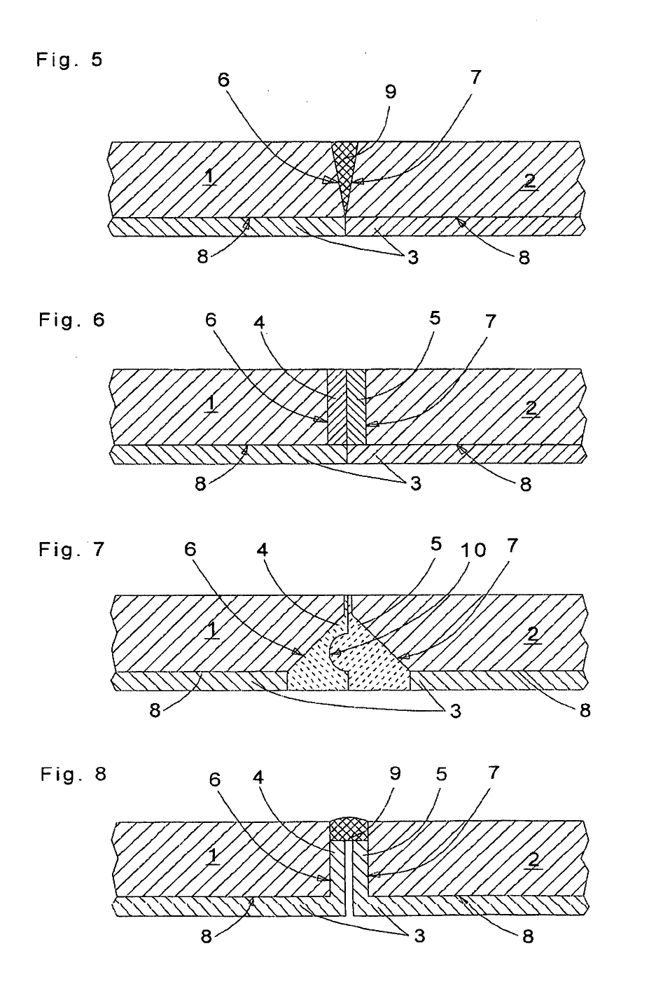

FIG. 5 a detail of a floor covering in which the flanks of the stone tiles are not parallel (different shape than the one in FIG. 4);

FIG. 6 a detail of a floor covering in which the flanks of the stone tile were subsequently provided with an overhang;

FIG. 7 a detail of the floor covering in which the flanks of the stone tile were subsequently provided with an overhang, and this overhang is profiled; and

FIG. 8 a detail of a floor covering in which the flanks of the stone tiles were only partly provided with an overhang, and the join is a convex join.

In FIG. 1, a vertical section through the floor covering according to the invention, according to the first embodiment, is shown. Stone tiles 1, 2 lie on a thermoplastic material 3 with their underside 8. There is also thermoplastic/elastic material 3 on the flanks 6, 7 of the stone tiles 1, 2, which material has been pushed up during the production of the floor covering, here during pressing, thereby forming the overhangs 4, 5.

Since the floor covering can also be broken up into smaller panels after its production, joins 9 can form on the floor, if applicable, when the floor covering is laid on a floor.

However, these joins can be chosen intentionally for esthetic reasons. Here, the join width can amount to between 0 to 4 mm. The join material can then either also consist of a thermoplastic material, or of a self-hardening join sealing mass, or of a mineral material.

In order to be able to handle the floor covering better—for example when laying it in corners, at edges, or projections of the floor, or when laying patterns or images—it must be separated into smaller units after its production. These units can be produced down to the smallest size—the size of an individual stone tile. In the case of small-format stone tiles, there is the possibility of fixing several of these tiles in place on an elastic subsurface as a laying aid. Preferably, oscillating blades are used to cut the floor covering into pieces; these are driven by means of high-frequency oscillators. However, circulating saw belts or saw wires are also possible.

FIG. 2 differs from FIG. 1 in that here, no overhangs 4, 5 are present.

Since stone tiles 1, 2 generally do not have precise flanks 6, 7, the stone tiles 1, 2 should be laid with joins. Here, the join width is assumed to be less than 4 mm.

In FIG. 3, the upper ends of the overhangs 4, 5 do not reach all the way to the upper edge of the stone tiles 1, 2. This can be intentionally produced in this manner, in order to be able to place a decorative join 9, but also for the reason that the thermoplastic material used might not be sufficiently capable of flow. The upper end of the overhangs would then be cut off in a separate work step.

A different method of laying the floor covering is illustrated in FIG. 4. Here, the flanks 6, 7 of the stone tiles 1, 2 are inclined in such a manner that the upper edges of the stone tiles abut one another. Here, a join 9 can then be eliminated. Within the scope of this embodiment, the upper tips of the stone tiles 1, 2 can also be configured to be parallel in their upper region.

In contrast to FIG. 4, in FIG. 5 the incline of the flanks goes in the other direction. Here again, there are no overhangs 4, 5. Therefore a join 9 is required.

In contrast to FIG. 1, in FIG. 6 the overhangs 4, 5 have been produced in a separate work step, in other words after the thermoplastic material 3 was connected with the underside 8 of the stone tiles 1, 2. However, the overhangs 4, 5 shown here can also consist of thermoplastic material, but also of a different material within the scope of the invention.

If a corresponding production precision is present, the stone tiles 1, 2—if desired—can then also be laid without joins.

With the exemplary embodiment according to FIG. 7, it is supposed to be shown how overhangs 4, 5 applied subsequently can be configured in such a manner that they serve for dimensionally accurate laying. The stone tiles 1, 2 that abut one another are centered and fixed in place by means of a profiling 10 in the stone tiles 1, 2, with a positive or negative shape. This profiling 10 is shown as a half-circle in FIG. 7. Within the scope of the present invention, however, the profiling 10 can also be configured in zigzag shape or as a tongue and groove combination.

FIG. 8 is similar to FIG. 3. However, here the join 9 does not go as deep. Furthermore, the join 9 is provided with a convex curvature. For design reasons, however, the join 9 can also be provided with a concave curvature.

This disclosure offers illustrative embodiments according to the invention as examples and not as restrictions.

### REFERENCE SYMBOL LIST

1 stone tile
2 stone tile
3 thermoplastic material
4 overhang
5 overhang
6 flank
7 flank
8 underside
9 join
10 profiling
a spacing

1. Floor covering consisting of at least one layer of a thermoplastic material (3), wherein
sections of the surface of the floor covering consist of stone tiles or a natural material, whereby these sections are disposed spaced apart from one another, in each instance, or to lie against one another, in each instance.

2. Floor covering according to claim 1, wherein
the stone tiles (1, 2) are disposed on the surface or partly in the surface of the floor covering, whereby the thermoplastic material (3) wets the underside (8) of the stone tiles (1, 2) and the two materials enter into a firm connection with one another.

3. Floor covering according to claim 2, wherein
multiple stone tiles (1, 2) are disposed on a fitted section of the floor covering.

4. Floor covering according to claim 2, wherein
the flanks (6, 7) of the stone tiles (1, 2)—at least in part—are also wetted with the thermoplastic material (3) and thereby form a so-called overhang (4, 5).

5. Floor covering according to claim 2, wherein
the flanks (6, 7) of the stone tiles (1, 2)—at least in part—are also wetted with a thermoplastic material (3) and thereby form a so-called overhang (4, 5), whereby this material differs, in terms of its composition, from the thermoplastic material (3) underneath the stone tiles (1, 2).

6. Floor covering according to claim 4, wherein
the overhang (4, 5) is applied to the flanks (6, 7) of the stone tiles (1,2) in a separate work step, in other words after the thermoplastic material (3) has been connected with the stone tiles (1, 2).

7. Floor covering according to claim 4, wherein
the overhang (4, 5) has a profiling (10) that is structured in such a manner that it can engage into a profiling of the overhang (4, 5) of an adjacent stone tile (1, 2) essentially without a gap.

8. Floor covering according to claim 7, wherein
the profiling (10) is structured in semi-circular shape.

9. Floor covering according to claim 7, wherein
the profiling (10) is structured in zigzag shape.

10. Floor covering according to claim 7, wherein
the profiling (10) is configured as a tongue/groove profiling.

11. Floor covering according to claim 2, wherein
at least one additional layer is disposed underneath the stone tiles (1, 2), in addition to the thermoplastic material.

12. Floor covering according to claim 11, wherein
the additional layer consists essentially of elastic plastics and/or natural materials.

13. Floor covering according to claim 2, wherein
the thermoplastic material (3) and/or the additional layer is configured to be electrically conductive.

14. Floor covering according to claim 13, wherein
an electrostatic discharge takes place by way of the joins between the stone tiles (1, 2).

15. Floor covering according to claim 1, wherein
the thermoplastic material (3) and/or the additional layer is configured to be self-adhesive.

16. Floor covering according to claim 1, wherein
the thermoplastic material and/or the additional layer is configured to be magnetic.

17. Floor covering according to claim 1, wherein
the sections of the surface of the floor covering consist of a natural material in the form of a finely splittable stone material in the form of stone films, whereby the finely splittable stone material is the visible layer of the floor covering after it has been laid.

18. Floor covering according to claim 17, wherein
the stone film consists of natural slate or Indian slate or mica.

19. Floor covering according to claim 17, wherein
the stone film has a layer thickness of 1 to 3 mm, preferably a layer thickness of 1 to 1.5 mm.

20. Floor covering according to claim 17, wherein
an intermediate layer is disposed underneath the stone film, which layer essentially consists of an elastic material, whereby the intermediate layer contains thermoplastic ingredients such as rubber meal, rubber granulate, cork meal and/or natural fibers.

21. Floor covering according to claim 20, wherein
another layer is disposed underneath the intermediate layer, which layer essentially consists of an elastified natural material and an elastified binder.

22. Floor covering according to claim 21, wherein
the natural material of the additional layer contains cork and/or bamboo fibers and/or coconut fibers and/or sisal fibers.

23. Floor covering according to claim 21, wherein
the natural materials are wetted with a thermoplastically deformable material.

24. Floor covering according to claim 1, wherein
the sections of the surface of the floor covering consist of a natural material in the form of a finely splittable wood material in the form of a veneer, whereby the finely splittable wood material is the layer of the floor covering that is visible after it has been laid.

25. Floor covering according to claim 24, wherein
the veneer has a layer thickness of 0.5 to 5 mm, preferably a layer thickness of 1 to 2 mm.

26. Method for the production of a floor covering according to claim 1, in which, in a double-belt press,
first, a component of a floor covering, preferably the thermoplastically deformable starting materials, particularly thermoplastic granulate, and on top of that, another component of the floor covering, preferably the stone tiles or the natural material, particularly stone films or wood films, for example veneer, is uniformly placed onto a circulating lower belt,
during the further production sequence, a circulating upper belt presses down onto the starting material,
in the conveying gap between the two belts of the double-belt press, the starting materials are heated or partly melted by means of a heating system, and pressed together with one another,
whereby the pressing takes place by way of pressing plates and/or pressing rollers disposed in pairs on the side of the belts that faces away from the material to be pressed,
so that the stone tiles or the natural material, as a section of the surface of the floor covering, in each instance, is integral with the carrying layer of the floor covering, the thermoplastic material, and at least the underside of each stone tile or each natural material is wetted by the thermoplastic material,
and finally, cooling of the floor covering that has been formed in this manner takes place, and this is then cut to length in panels or webs.

27. Method according to claim 26, wherein
before entry of the starting materials placed onto the lower belt into the conveying gap, an auxiliary belt that is elastic in thickness is laid between the surface of the stone tiles or of the natural material and the corresponding belt, which belt runs through the conveying gap along with the material.

28. Method according to claim 26, wherein
the floor covering formed from the thermoplastic material and the stone tiles or the natural material is calibrated to a predetermined thickness in the conveying gap.

29. Method according to claim 26, wherein
first, the stone tiles or the natural material, and then the thermoplastically deformable starting materials are uniformly placed on the circulating lower belt.

30. Method according to claim 29, wherein
first, an auxiliary belt that is elastic in thickness, then, uniformly, the stone tiles or the natural material, and then, uniformly, the thermoplastically deformable starting materials are placed on the circulating lower belt.

31. Method according to claim 26, wherein
the pressure on the pressing plates is increased in such a manner that the thermoplastic material (3) is also pressed into the joins (9) between the stone tiles.

32. Method according to claim 31, wherein
the pressure on the pressing plates is controlled in such a manner that the thermoplastic material (3) is not pressed out beyond the upper edge of the stone tiles.
